(19) United States
(12) Patent Application Publication
(10) Pub. No.: US 2025/0141256 A1
(43) Pub. Date: May 1, 2025

(54) VEHICLE POWERED ELECTRICAL CHARGING DEVICES AND METHODS

(71) Applicant: Brian Patrick Janowski, Marquette, MI (US)

(72) Inventor: Brian Patrick Janowski, Marquette, MI (US)

(21) Appl. No.: 18/929,454

(22) Filed: Oct. 28, 2024

Related U.S. Application Data
(60) Provisional application No. 63/564,733, filed on Mar. 13, 2024.
(60) Provisional application No. 63/546,200, filed on Oct. 28, 2023.

(51) Int. Cl. H02J 7/14; B60L 53/16; B60L 53/53; B62J 11/00; B62J 43/13; H01F 27/08

(52) U.S. Cl. CPC H02J 7/14; B60L 53/16; B60L 53/53; B62J 11/00; B62J 43/13; B60L 2200/12; H01F 27/08; H02J 2207/20

(57) ABSTRACT

A vehicle powered step-up charging device (SUCD). The SUCD can be in a terminal version which plugs in at the terminal end of a vehicle supplied power supply, such as a 7-pin RV socket. Alternatively, the SUCD is an in-line version where it is situated between the vehicle's powerplant and a RV socket. In another alternative, the SUCD is a bottle SUCD version having a form for seating within a bottle holder of a bicycle. In this case, an input line couples to a 12V output on the vehicle. Circuitry inside the bottle SUCD steps up voltage which is then output via an output line for charging one or more devices such as an electric bike during transit on a bike rack. This disclosure includes configurations for delivering the stepped up voltage at an RV socket as well as methods for using terminal, in-line, or bottle SUCDs.

### CROSS REFERENCE TO RELATED APPLICATIONS

This application claims priority to Provisional Patent Application No. 63/564,733 filed Mar. 13, 2024 and Provisional Patent Application No. 63/546,200 filed Oct. 28, 2023, the entire disclosures of which are hereby incorporated by reference and relied upon.

### BACKGROUND OF THE INVENTION

Field of the Invention. The invention relates generally to electrical charging devices, and more particularly to vehicle powered electrical charging devices integrated into electrical plugs that plug into the vehicle, within power lines extending from a vehicles electrical powerplant, and within bike accessories drawing power from a vehicle.

Description of Related Art. E-bikes and other electric motorized recreational vehicles typically depend on battery power to run their motors. Although there are many advantages to using electrical power over fossil fuels, one of the downsides of electric motorized recreational vehicles is the interrupted use of these devices when their batteries drain low. Unlike gas powered vehicles which can be refueled quickly with gasoline, the batteries in e-powered recreation vehicles take much longer to recharge and charging devices are often not readily available when needed. This becomes a problem when a user has a limited window of time in which to enjoy their e-bike or other e-powered device.

E-powered RV users typically charge their RV at home before leaving for a trip to the mountains, forests, lakes, and other getaways. Unfortunately, there are not good solutions for charging an e-powered recreation vehicle once the owner leaves home or while traveling. 120V Car inverters are available and often used inside the cab of a vehicle for plugging in a 120V power supply for powering computers and other devices. This arrangement is typically of no use to charge various kinds of electric RVs such as e-bicycles that are commonly transported in the back of a truck or on a vehicle mounted bike rack.

What is needed are simplified charging devices to charge electric RVs during their transport by a motor vehicle in the back of a truck or car or on a bike rack. What is needed are simplified charging devices to charge to charge any array of battery operated devices such as hand tools.

USCAR is an automotive research organization that aims to improve American automotive technology through cooperative research and development. USCAR stands for United States Council for Automotive Research. A USCAR 7-way socket is a standardized automotive electrical socket that provides a connection point for trailer wiring. The socket is used across several different makes and models, allowing for easier access to parts for both manufacturers and vehicle owners. Examples of vehicles that use an USCAR 7-way socket include GMC, Ford, Chrysler, Toyota, and Honda. While some vehicles don't use the USCAR 7-way socket, they have a different standardized socket solution. Some Dodge vehicles, for example, and others use a rectangular, 8-prong configuration.

### SUMMARY OF THE INVENTION

Disclosed herein is a vehicle powered step-up charging device (SUCD) and methods for its use.

In one form, an in-line SUCD is positioned within vehicle circuitry and destined to deliver stepped-up voltage at an RV electrical socket such as those typically located at the rear bumper of a vehicle.

In one form, the stepped-up voltage from an in-line SUCD can be delivered as a separate terminal integrated within the vehicle's 7-pin or 4-pin RV socket or within a dedicated stepped-up RV socket providing the stepped-up voltage.

In one form, a terminal SUCD can plug into the 7pin RV socket (which can be part of a bumper RV socket that is mountable at the vehicle's bumper). The SUCD provides a convenient and quick option to provide a stepped-up voltage to chargeable devices at the back of a vehicle requiring voltage that is higher than the standard 12 volts provided by a vehicle.

In one form, a water bottle SUCD has a standard water bottle profile that can be seated in a standard water bottle holder of a bicycle. Here, 12V input is drawn from the vehicle's electrical supply such as a 7-pin or 4-pin RV socket to the SUCD, and stepped-up output electrical lines extend from the water bottle SUCD to one or more bicycles, tools, or other chargeable device for charging.

In one form, a bumper RV socket comprises a stepped-up voltage lead.

In one form, the stepped-up voltage lead is integral to a 7-pin RV socket.

In one form, the stepped-up voltage lead is spaced from the 7-pin RV socket on the bumper RV socket.

### BRIEF DESCRIPTION OF THE SEVERAL VIEWS OF THE DRAWINGS

These and other features and advantages of the present invention will become more readily appreciated when considered in connection with the following detailed description and appended drawings, wherein each drawing is according to one or more embodiments shown and described herein, and wherein:

FIG. 1 depicts a distal top perspective view of a vehicle powered terminal step-up charging device (SUCD);

FIG. 2 depicts a proximal cross-sectional view of the SUCD of FIG. 1 through plane B;

FIG. 3 depicts a proximal perspective view of the SUCD of FIG. 1 with output circuitry removed;

FIG. 4 depicts an inferior perspective view of the SUCD of FIG. 1;

FIG. 5 depicts a distal top exploded perspective view of the SUCD of FIG. 1 with circuitry removed;

FIG. 6 depicts a distal bottom exploded perspective view of the SUCD of FIG. 1;

FIG. 7 depicts a proximal perspective view of a 7-pin RV plug;

FIG. 8 depicts a distal perspective view of the 7-pin RV plug of FIG. 7;

FIG. 9 depicts a top partially exploded perspective view of a terminal SUCD with circuit board sealed within a circuit board cavity of the SUCD with output circuitry removed;

FIG. 10 depicts a proximal partially exploded perspective view of the SUCD of FIG. 9 with circuit board more fully removed;

FIG. 11 depicts a proximal partially exploded perspective view of the SUCD of FIG. 9;

FIG. 12 depicts a distal perspective view of a terminal SUCD having a terminal shell that is assembled in two halves with output circuitry removed;

FIG. 13 depicts a distal perspective exploded view of the SUCD of FIG. 12;

FIG. 14 depicts a proximal view of a 7-pin RV plug used with the SUCD of FIG. 12;

FIG. 15 depicts a distal perspective view of a terminal SUCD;

FIG. 16 depicts a proximal perspective view of the SUCD of FIG. 15;

FIG. 17 depicts an exploded view of the SUCD of FIG. 15 with outlet port and output circuitry removed;

FIG. 18 depicts a proximal perspective view of the SUCD of FIG. 17;

FIG. 19 depicts a top perspective view of an in-line SUCD;

FIG. 20 depicts a bottom perspective view of the in-line SUCD of FIG. 19 from an opposing end;

FIG. 21 depicts a cross-sectional view of the shell and terminals of the SUCD of FIG. 19;

FIG. 22 depicts an exploded view of the SUCD of FIG. 19;

FIG. 23 depicts a partially exploded view of an in-line SUCD wherein a circuit board is sealed within a circuit board cavity of an in-line shell;

FIG. 24 depicts a distal perspective view of a bumper RV socket configured to deliver stepped up power;

FIG. 25 depicts a proximal perspective view of the bumper RV socket of FIG. 24 having a stepped voltage lead;

FIG. 26 depicts a proximal view of a bumper RV socket with a hi/lo switch;

FIG. 27 depicts a side view of the bumper RV socket of FIG. 25;

FIG. 28 depicts a distal view of a bumper RV socket having an interior step-up lead;

FIG. 29 depicts a distal perspective view of a bumper RV socket having an interior step-up lead;

FIG. 30 depicts a flow diagram of a method of using an in-line SUCD to supply stepped-up voltage to use for charging a device;

FIG. 31 depicts a flow diagram of a method for using a terminal SUCD to supply stepped-up voltage to use for charging a device;

FIG. 31A is a graphic depicting the use of an in line SUCD within a vehicle to supply stepped-up voltage for charging a device such as an E-bike;

FIG. 32 depicts a common mounting location of a bumper RV socket on a vehicle;

FIG. 33 depicts a common form of a 7-pin trailer plug with positive auxiliary power terminal and ground terminal in relation to an outer alignment boss;

FIG. 34 depicts typical wiring of a 7-pin RV trailer plug;

FIG. 35 depicts a common USCAR 7 way socket;

FIG. 36 depicts a Dodge socket;

FIG. 37 depicts a perspective view of a bottle SUCD that can be removably secured in a bicycle's bottle holder;

FIG. 38 depicts an opposing side perspective view of the bottle SUCD of FIG. 37;

FIG. 39 depicts an exploded perspective view of the bottle SUCD of FIG. 37;

FIG. 40 depicts a side view of a bottle SUCD seated within a bottle holder attached to a bike frame;

FIG. 41 depicts a diagram of steps in a method of using a bottle SUCD to charge an E- bike.

### DETAILED DESCRIPTION OF SELECTED EMBODIMENTS OF THE INVENTION

Select embodiments of the invention will now be described with reference to the Figures. Like numerals indicate like or corresponding elements throughout the several views and wherein various embodiments are separated by letters (i.e. 100A, 100B, 100C). Elements without letters represent general elements cooperating with the various embodiment. The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

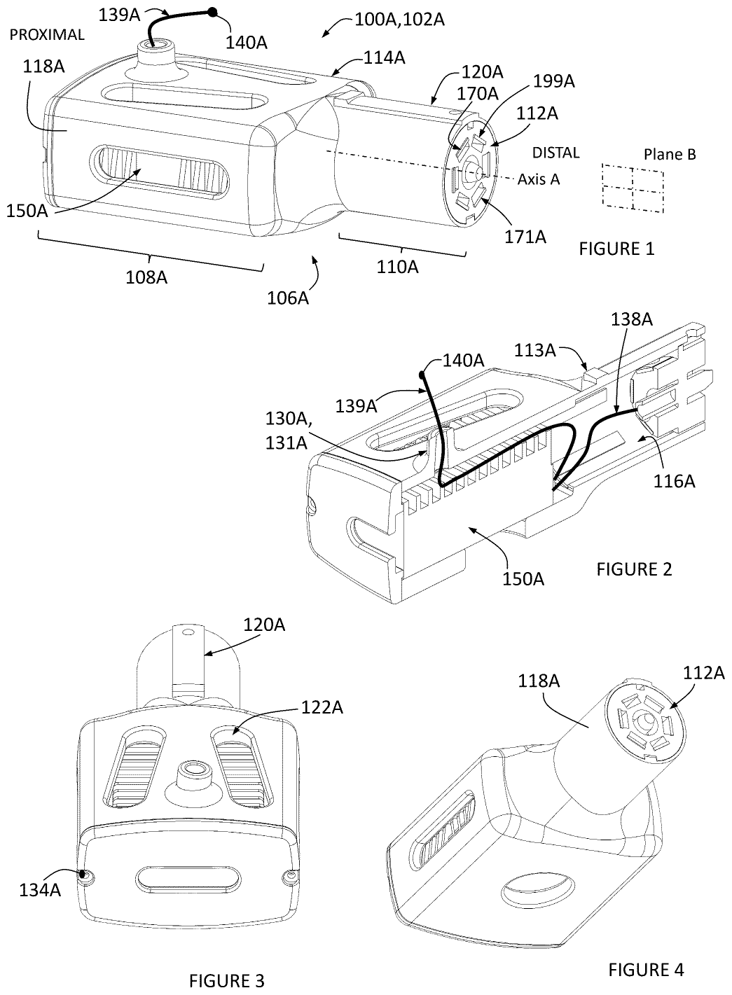

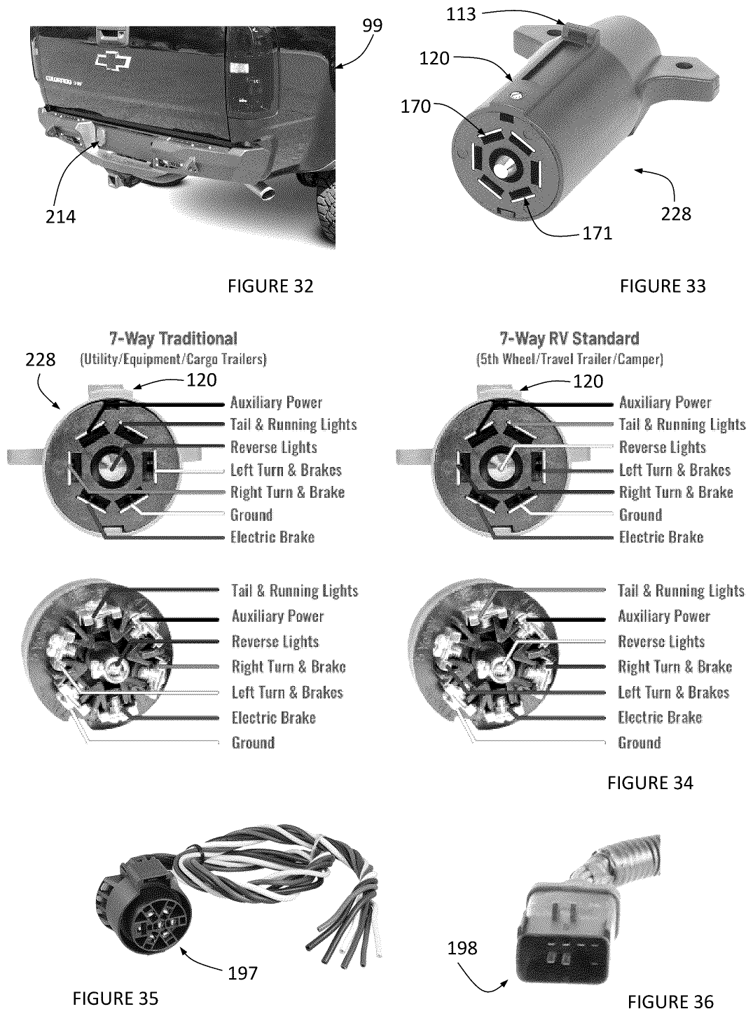

Disclosed herein is a vehicle powered step-up charging device (SUCD). In some embodiments, such as the SUCD 100A depicted in FIG. 1, the device comprises a 7-pin RV plug 112A configured for mating with a 7-pin RV electrical connector (i.e. bumper RV socket 214) mounted to the rear of a vehicle 99 such as a car or truck (FIG. 32). A bumper RV socket 214 is common standard equipment on vehicles to provide one or more of lighting power, electric brake control, and 12V auxiliary power to trailers pulled by the vehicle and which is supplied by a vehicle powerplant 101 of the vehicle via the vehicle's trailer wiring harness 103. FIG. 33 depicts a common 7-pin RV plug that carries the electrical signals from the vehicle's powerplant 101 to the trailer. FIG. 34 depicts a typical wiring pattern on the 7-pin RV trailer plug wherein the electrical terminals are positioned relative to outer alignment boss 120. As noted in the Figure, the positive auxiliary power terminal (+12V from the vehicle) is positioned directly opposite the ground connector terminal. In addition, the positive auxiliary power terminal is located approximately 45 degrees counter-clockwise from the outer alignment boss when viewed from the terminal end.

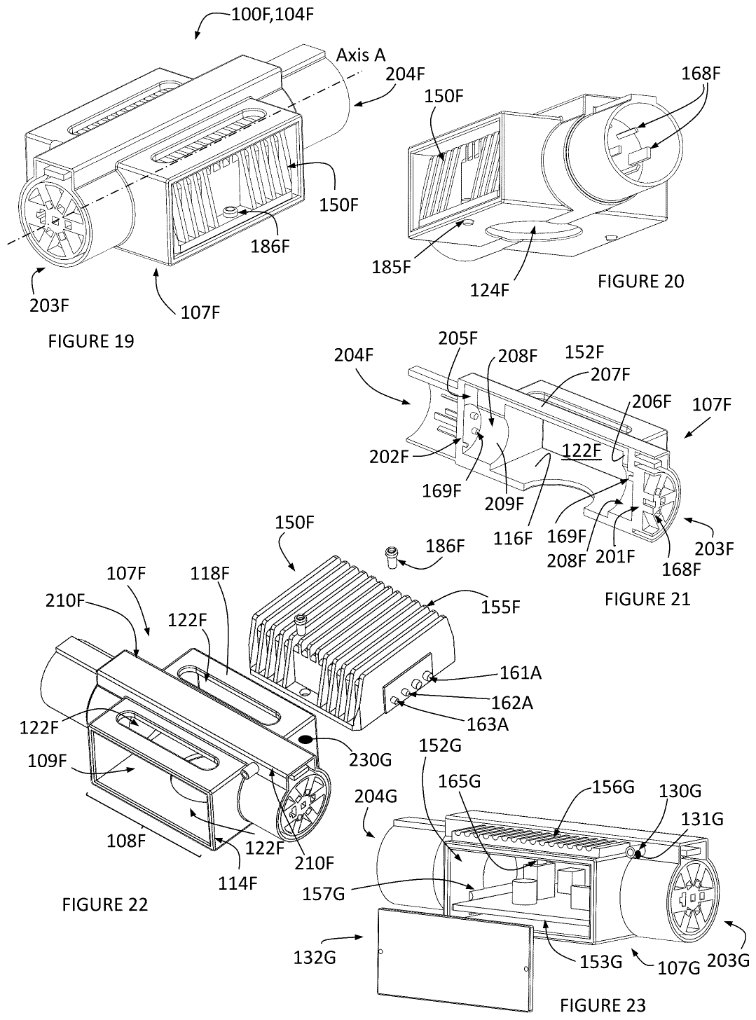

In some embodiments (i.e. FIG. 1, 5, 9), an SUCD 100A, 100B is configured for use at the terminal end of a vehicle's electrical system by plugging into a vehicle's bumper RV socket 214 for example. A terminal shell 106A, 106B is used to house components of this style SUCD known as a terminal SUCD 102A,102B. In other embodiments (i.e. FIG. 19, 23), a SUCD is configured for use in-line of a vehicle's electrical system and is therefore mounted under the vehicle between the electrical supply lines coming from the vehicle's powerplant and the electrical termination at the vehicle's bumper RV socket 214. This is referred to as an in-line SUCD 104F, 104G. An in-line shell 107F, 107G is used to house components of this style SUCD. In some embodiments, the terminal shell and in-line shell are manufactured from a polymer such as polycarbonate, HDPE, nylon, or other polymers or composites known in the art although they can be made of other materials such as metals or composites. The shells can be vented to help with cooling of the electrical components disposed therein. In some embodiments, such as when the shell completely encloses a circuit board from the weather elements, the shell can be manufactured from a metal (using the shell as a heat sink) or comprise adjunct cooling fins 156B on the exterior of the shell coupled with hot electrical components of the circuit board. The adjunct cooling fins 156B can take on a variety forms such as a plain metal or finned metal plate secured to the surface of the shell.

As further noted in the embodiment in FIG. 1-6, terminal shell 106A comprises a step-up housing 108A. The step-up housing is configured for housing one or more circuit boards 153B or an entire transformer assembly 150A therein. A transformer assembly comprises step-up circuitry and sometimes other circuitry to monitor the state of a battery and is sealed with a sealant 154A or other weatherproofing within in a circuit board cavity 152A of a heat sink body 151A. The heat sink body is typically a casted aluminum. Terminal shell 106A also comprises an RV plug housing 110A which extends from the step-up housing 108A. The RV plug housing in this embodiment is generally cylindrical along axis A and configured to house a 7-pin RV plug 112A therein at a distal end. In some embodiments, a portion of the step-up housing 108A is open at a proximal end, lateral side, top or bottom, for docking the transformer assembly or other circuit board inside. As depicted, the open end or side of the step-up housing 108A of the terminal shell 106A is defined by an end face 115A which in this embodiment is substantially flat. A cavity cover 132A configured to cover the open end/side of step-up housing 108A can be used. The cavity cover can include one or more fastener holes 135A to house cover fasteners 134A that can be driven into shell wall 114 thereby securing the cavity cover to the terminal shell. Cavity cover 132A can comprise an alignment boss 136A to center the cavity cover over the open step-up cavity 109A and can also include a cover vent 133A to provide additional cooling through the cover. Likewise, the step-up housing 108A can include one or more shell vents 122A extending between an internal face 116A and an external face 118A to assist cooling by exposing cooling fins 155A that extend outward from the heat sink body 151A to outside air. In addition, a drain vent 124A on an inferior side of the step-up housing extends between the internal and external faces. This vent is present to assist drainage of liquids through the terminal shell but it can also assist in cooling. One or more drain vents can be included in the RV plug housing if desired or these compartments can be sealed from moisture.

As noted earlier, transformer assembly 150A comprises step-up circuitry sealed with a sealant 154A or using other weatherproofing within in a circuit board cavity 152A of a heat sink body 151A. The heat sink body is typically of a casted aluminum. In some embodiments, the heat sink body 151A comprises a mount ridge 158A formed within a portion of the body. The mount ridge in this embodiment extends at least partially lengthwise along opposing sides of the heat sink body with a mount face 149A thereon, and can be utilized to secure the transformer assembly to an anchor site. A mount hole 159A extending through the mount face of the mount ridge can be used to house a mount fastener 160A to secure the transformer assembly in a fixed position to other parts of the device. In other embodiments, the transformer assembly can be secured using other methods known in the art such as adhesives or positioning between cavity walls.

The various terminal shells, and in-line shells are formed of a shell wall (i.e. 114A, 114F) having an internal face (i.e. 116A, 116F) and an external face (i.e. 118A,118F). The internal face defines a step-up cavity (i.e. 109A,109F, 109K) of a size and shape for housing a transformer assembly (i.e. 150A, 150C) or step-up circuit boards (i.e. 153B) therein. In most embodiments, the step-up cavity is substantially square or rectangular and generally box shaped although other shape profiles can be used to contain these items. In some embodiments, extending into or from the internal face is one or more anchor holes or board retainers (i.e. 157B) for securing the transformer assembly and/or circuit board in place. For example, in FIG. 10, the board retainers 157B are in the form of raised extended bosses whereby a circuit board is slid in and captured there between. In other embodiments, the board retainer can be in the form of elevated bumps, grooves, fasteners, clips, adhesives, or other features known in the art capable of retaining a circuit board.

As depicted in FIG. 6 for example, internal face 116A defines a generally cylindrical plug cavity 126A along axis A and larger diameter plug receiver 127A sized to seat a 7-pin RV plug 112A. A stop face 128A serves as a block assuring the mate face 143A of 7-pin RV plug 112A remains generally flush with distal face 142A of the RV plug housing 110A in an operational configuration. Plug cavity 126A can contain an inner alignment boss 121A for aligning with elongate alignment groove 119A of the 7-pin RV plug assuring 7-pin RV plug 112A is properly aligned (with respect to outer alignment boss 120A) resulting in correct electrical mating with the bumper RV socket 214 when joined. A closed ended lock groove 117A inset in 7-pin RV plug 112A receives the end of a lock screw 125A when driven through lock receiver 123A which can be pre-threaded. Protruding from an external face 118A of RV plug housing 110A and parallel to axis A is an outer alignment boss 120A which assures alignment of the 7-pin RV plug 112A within a bumper RV socket 214 for proper electrical connection. Radially raised from a proximal end of outer alignment boss 120A is a lock catch 113A which is used to secure the RV plug housing 110A in a standard 7-pin RV socket 216. In a retained configuration, a lock tab portion on a 7-pin cover with lock tab 217J engages the lock catch thereby preventing the RV plug housing from moving away from the socket without lifting the 7-pin cover out of the way. Once the 7-pin cover with lock tab is moved upwards to disengagement from the retained configuration, the SUCD can be retracted from the socket. The circuit board 153B can comprise one or more transmission bosses 165B for the transmission of heat from hot electrical components to one or more heatsinks (i.e. adjunct cooling fins 156B).

Extending from the circuit board (i.e. 153B) are terminals or leads for input power 161A (typically 12V DC), a stepped up output power 162A (typically between 30V to 60V and sometimes as high as 90V), and adjunct leads 163A that communicate with circuitry that performs additional functions such as for example, monitoring battery temperature or charge levels, balancing levels between cells and circuitry that prevents over discharging. A power gasket 164A can be present to seal these leads from outside elements as they enter the circuit board cavity 152A.

FIGS. 7-8 depict views of one style of 7-pin RV plug 112A that is locked into RV plug housing 110A by lock screw 125A. An alternative style of 7-pin RV plug 112C is secured in place by interlocking of a shell tongue 174C into plug grooves 172C of 7-pin RV plug 112C upon assembly. Other style RV plugs can be used and adapted accordingly to their features. As in earlier embodiments, 7-pin RV plug 112C comprises both internal terminals 169C in electrical communication with external terminals 168C housed in plug body 167C. Terminal screws 324C on the interior terminals (i.e. 169A,169C) are used to secure wire ends from input circuitry 138A traveling to input power 161A on the transformer assembly and circuit board. Output circuitry 139A from the output power 162A travels towards outlet port 130A where it can exit for use as a stepped-up voltage such as needed to charge an electric bike. The output circuitry 139A can terminate in an output coupler 140A which in most cases is in the form of an electrical plug depending on requirements of the electrical device to be charged. Electrical energy from the output coupler 140A can be used for purposes such as plugging into an electric bike to charge the bike's battery, or for charging batteries for tools, lights, or other devices for example. The output can be split so that multiple bikes can be charged at the same time or alternatively according to the needs of each battery.

In some embodiments, an outlet port 130A comprises a passage for the output circuitry 139A (i.e. wire/cable) to pass to the exterior of the step-up housing 108A as depicted in FIG. 2. Alternatively, outlet port 130A can be in the form of an electrical jack that can couple with a complementing jack with cable/wiring to extend toward the device that needs to be charged or powered. In some cases, the outlet port will include a clamp and/or seal to limit strain on the exiting cable/wiring and/or jack or to prevent the influx of weather elements in the case of versions having a weather sealed circuit board cavity 152B.

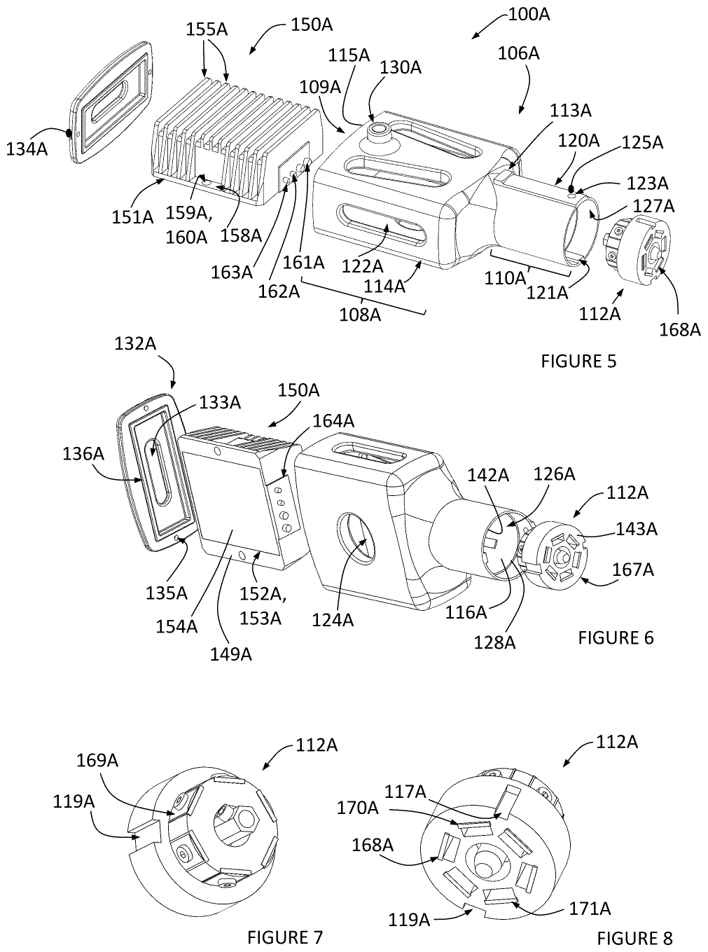

As noted in FIGS. 5-8, a 7-pin RV plug 112A comprising a positive auxiliary power terminal 170A and a ground terminal 171A is housed in a generally cylindrical RV plug housing 110A of the SUCD 100A. In preferred embodiments, the SUCD is plugged into a mating bumper RV socket 214 (7-pin RV electrical connector, FIG. 32) mounted at the rear of a vehicle in an operable configuration. Through this connection, the positive auxiliary power terminal 170A is then able to draw 12V power from the vehicle, and ground terminal 171A is also in electrical communication with the mating bumper RV socket ground terminal. In alternative embodiments, the tail and running lights terminal 199A can be used as a source of power for charging assuming the driver of the vehicle is willing to keep their tail/running lights illuminated during the day. This holds true for the tail and running lights terminal on a standard 4-way RV plug which can also be used for charging.

The step-up housing (i.e. step-up housing 108A for example) can be utilized as a handle when plugging and unplugging the SUCD 100A from a standard 7-pin RV socket (i.e. bumper RV socket 214). In preferred embodiments, the step-up charging device steps up the voltage from approximately 12 volts to a range between 18V to 72V.

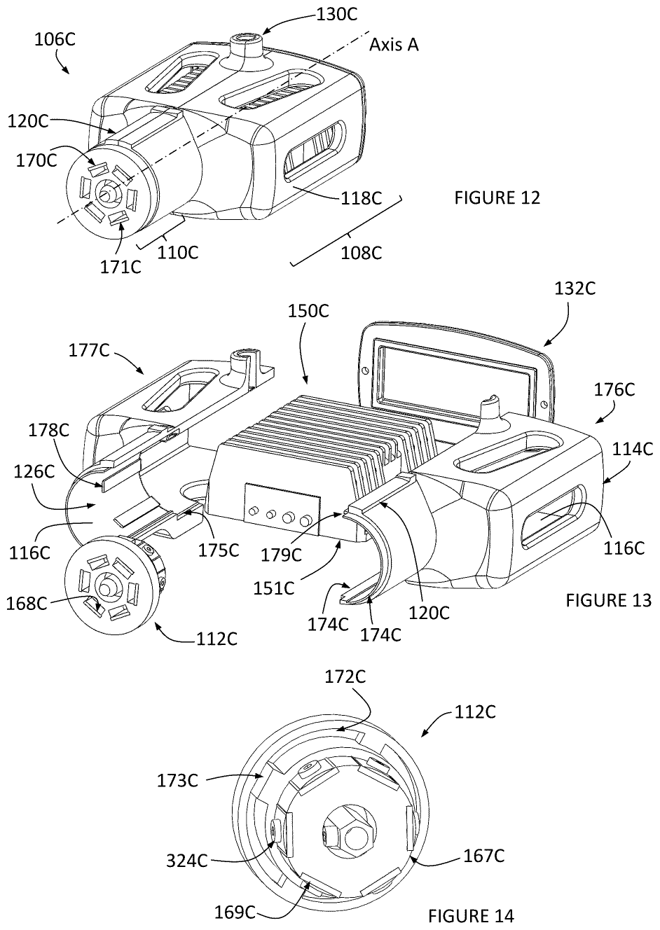

Depicted in FIGS. 12-14 is yet another embodiment of a SUCD 100C. This embodiment comprises a terminal shell 106C assembled from a plurality of interlocking parts. For example, the Figures depict a first shell 176C that interlocks with a second shell 177C that are divided by a mid-plane extending along a central axis forming essentially the two halves. In this case, one of the divided shells comprises a shell tongue 174C extending from the shell that is received by a shell groove 175C inset in the shell when the first shell and second shell are interlocked together at their mating plane. In this embodiment, 7-pin RV plug 112C assists in securing the first shell 176C and second shell 177C together. Here, shell tongue 174C extending from the distal end of the SUCD is configured to be received in the arc shaped plug grooves 172C thus preventing separation of the shells. The 7-pin RV plug 112C comprises a plug alignment boss 173C for housing in a plug alignment recess 179C that is aligned with outer alignment boss 120C and formed at a distal end of the first shell 176C and second shell 177C. Extending along the internal face 116C of RV plug housing 110C can be one or more ribs 178C to provide additional support to the housing. At the proximal end of the SUCD 100C is a cavity cover 132C with features as depicted previously in FIG. 5-6.

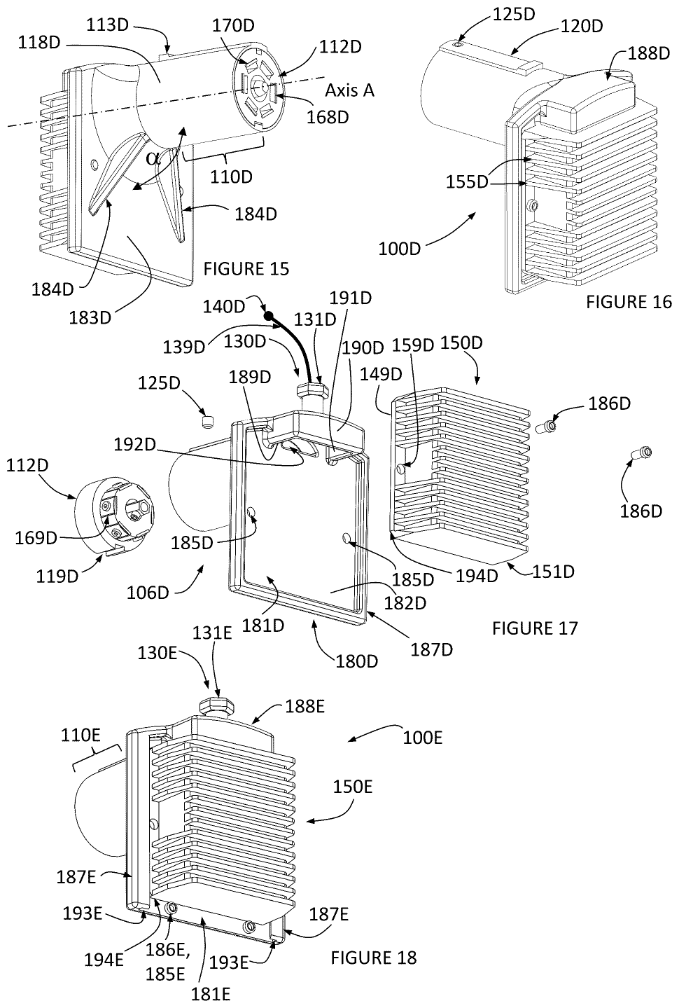

It is noted that the circuit board and/or transformer assembly for the SUCD can be orientated in any variety of planes with respect to the RV plug housing. In previous embodiments for example, transformer assembly 150A/150C and circuit board 153B were orientated in a plane substantially parallel to axis A. However, this orientation can vary in angle with respect to axis A (i.e. a from 0 to 90 degrees). For example, as depicted in FIGS. 15-18, transformer assembly 150D is orientated in a plane substantially perpendicular to axis A.

FIGS. 15-18 also depict an embodiment whereby the transformer assembly 150D is not enclosed in a step-up or circuit board cavity, although it is clear that such a cavity could be formed thereabout. In this embodiment, transformer bed 180D is joined with a proximal end of RV plug housing 110D of terminal shell 106D. The transformer bed is depicted here as a substantially flat plate made of an anchor wall 181D having an under face 183D on a distal side of the anchor wall and an opposed anchor face 182D facing proximally on which the transformer assembly 150D can mount. One or more gussets 184D can extend between under face 183D and external face 118D of RV plug housing 110D. One or more anchor holes 185D extend through anchor wall 181D and can be threaded. Transformer anchors 186D, here in the form of screws, rivets, or other fastener known in the art can be used to secure transformer assembly 150D to anchor face 182D. In some embodiments, a reinforcement rim 187D raises up from the periphery of anchor face 182D to add further reinforcement to anchor wall 181D and to serve as a partial buffer to the transformer assembly. Extending from anchor face 182D at one end is wiring canopy 188D that is opened facing the transformer assembly 150D. A abut face 189D at the bottom of wiring canopy 188D abuts and encircles a portion of the transformer assembly where the transformer leads exit (i.e. input power 161D, output power 162D, adjunct leads 163D) and enter wiring tunnel 192D eventually joining 7-pin RV plug 112D by traversing through plug cavity 126D of RV plug housing 110D. Wiring canopy 188D provides a degree of resistance to the wiring against weather elements and comprises an outer canopy face 190D opposite an inner canopy face 191D that defines the inside of the canopy. An outlet port 130D having a clamp and/or seal 131D extends through wiring canopy 188D for passage of output circuitry 139D. The output circuitry terminates in an output coupler 140D that couples directly with chargeable devices or couples with cables extending to other devices. In alternative embodiments, the outlet port 130E is in the form of an electrical jack that a charge cable can couple with.

FIG. 18 depicts a similar SUCD as depicted in FIGS. 15-17. However, the SUCD 100E depicted comprises a pair of spaced retaining grooves 193E extending into the pair of laterally spaced reinforcement rims 187E at the lateral sides of anchor wall 181E. Here the glide edges 194E of heat sink body 151E engage in the respective retaining groves as the transformer assembly 150E slides forward abutting wiring canopy 188E. One or more transformer anchors 186E are then secured in anchor holes 185E to hold the transformer assembly in position blocking it from backing out of the retaining grooves 193E.

Some of SUCDs disclosed are intended for docking within a bumper RV socket 214 (standard 7-pin RV socket). These sockets are typically designed to dock a relatively light 7-pin trailer plug such as depicted in FIG. 33 utilizing a 7-pin cover with lock tab 217J as illustrated in FIG. 25, 27 to retain the plug's mated position. Due to additional components, the SUCD is substantially heavier than the typical 7-pin trailer plug thus creating a greater moment force when docked. To minimize these moment forces and minimize chance of failure, in preferred embodiments, the transformer assembly and/or circuit boards used in the SUCD are preferably kept within 5 inches of the 7-pin RV plug 112. In preferred embodiments, this distance is within 2.5 inches of the 7-pin RV plug.

FIGS. 19-23 depict various versions of vehicle powered step-up charging device (SUCD) 100F, however, in this case it is an in-line SUCD 104F. Whereas the embodiments in FIGS. 1-18 are terminal SUCDs that step-up the voltage from the vehicle powerplant after it exits a bumper RV socket (i.e. 214), the in-line SUCD 104F steps up the voltage before arrival at a bumper RV socket. The in-line SUCD 104F is implemented between the electrical powerplant of the vehicle (comprising the signals depicted in FIG. 34) and the bumper RV socket 214. In most cases, the electrical output from the vehicle is via a standardized cable and electrical socket. The most widely used standard socket is a USCAR 7-way socket 197 (FIG. 35). Wiring from the vehicle to the USCAR socket supplies power for taillights, turn signals, electric trailer brakes, 12volt auxiliary power, reverse lights and brake lights, and a ground connection. Some vehicles don't use the USCAR 7-way socket and use their own different standardized socket solution. For example, some like Dodge and Jeep vehicles use a rectangular, 8-prong configuration called a Dodge socket 198 to deliver the electrical signals to the bumper RV socket. FIGS. 19-23 provides an example of an in-line SUCD 104F equipped with input and output versions of the USCAR 7-way socket, however, in alternative embodiments, it would be clear to those skilled in the art that the in-line SUCD can use other input and output sockets such as for example, a Dodge socket 198.

In-line SUCD 104F comprises an in-line shell 107F having step-up housing 108F portion for housing a transformer assembly 150F therein. The in-line shell comprises a shell wall 114F with an externally facing external face 118F and an internally facing internal face 116F on opposed sides of the shell wall and wherein the internal face defines a step-up cavity 109F where the transformer assembly 150F is housed. Extending between the internal face 116F and external face 118F can be one or more shell vents 122F to allow the dissipation of heat. Extending from one end of the in-line SUCD is a female socket 203F and a male socket 204F extending from the opposing end. This orientation is preferred since it generally aligns with the standard path of the wiring from the vehicle power plant back toward the bumper RV socket, however, other orientations can be used. Leading from the step-up cavity 109F in the in-line SUCD 104F is wiring pocket 208F defined by a wiring pocket face 209F serving as a wiring pathway between the respective socket and transformer assembly. At the end of the wiring pocket is a male base wall 202F having interior terminals 169F that extend through the wall and become external terminals 168F within male socket 204F. On the opposing end, at the end of the wiring pocket is a female base wall 201F again having interior terminals 169F that extend through the wall and become external terminals 168F within female socket 203F. Within the step-up cavity 109F is a wiring corridor 205F defined by an inner corridor face 206F which is a recess traveling from one wiring pocket 208F to the other to provide some degree of shelter to any wiring that needs to travel therebetween. An elongate outer corridor face 207F defines the outside of the wiring corridor 205F. It should be noted that in some embodiments, the in-line SUCD can be plugged directly into the USCAR 7-way socket of a bumper RV socket 214. However, in the absence of a direct connection, an appropriate USCAR jumper cable can be used allowing the in-line SUCD to be spaced from the bumper RV socket. The inline SUCD can also include one or more hanger restraints 210F for securing the inline SUCD to the under carriage of the vehicle. The hanger restraints can take the form of a loop for example engaging with cable, wire, or straps, or channels in the shell used to suspend the SUCD. A variety of other methods of securing are known in the art and can be utilized.

FIG. 21 depicts a cross-sectional view through in-line shell 107F including through the male and female sockets. As depicted in FIG. 19-22, anchor holes 185F extending through the shell wall 114F can be used to receive transformer anchors (i.e. screws/rivets) to secure the transformer assembly 150F within step-up cavity 109F. In some embodiments, the transformer assembly can be bonded to the shell. As before, the transformer assembly can alternatively be fixed to a shell wall without being enclosed within a step-up cavity such as depicted in FIGS. 15-18. Alternatively, a circuit board 153G for stepping up voltage and other functions can be housed within a sealed circuit board cavity 152G as depicted in FIG. 23. In this embodiment, externally shell placed adjunct cooling fins 156G can be coupled to a transmission boss 165G on the circuit board to provide a pathway for heat to be released exterior to the circuit board cavity 152G. A cavity cover 132G can be used as before to enclose and seal the cavity. As depicted here, board retainers 157G stabilize the circuit board within the circuit board cavity 152G. In FIGS. 19-23, the in-line shell 107G is molded as one-piece, however, as depicted in FIG. 13, the shell can be formed by an assembly of parts that snap or held together by other known means. In both cases, a fastener spanning the first shell and second shell can be used to add additional support. In yet another embodiment, in-line shell 107 can be open wherein it is absent of a step-up cavity. In this version, as before in FIGS. 17-18, an anchor wall extending between a male socket 204 and female socket 203 serves as a bed for the transformer assembly to be clamped to.

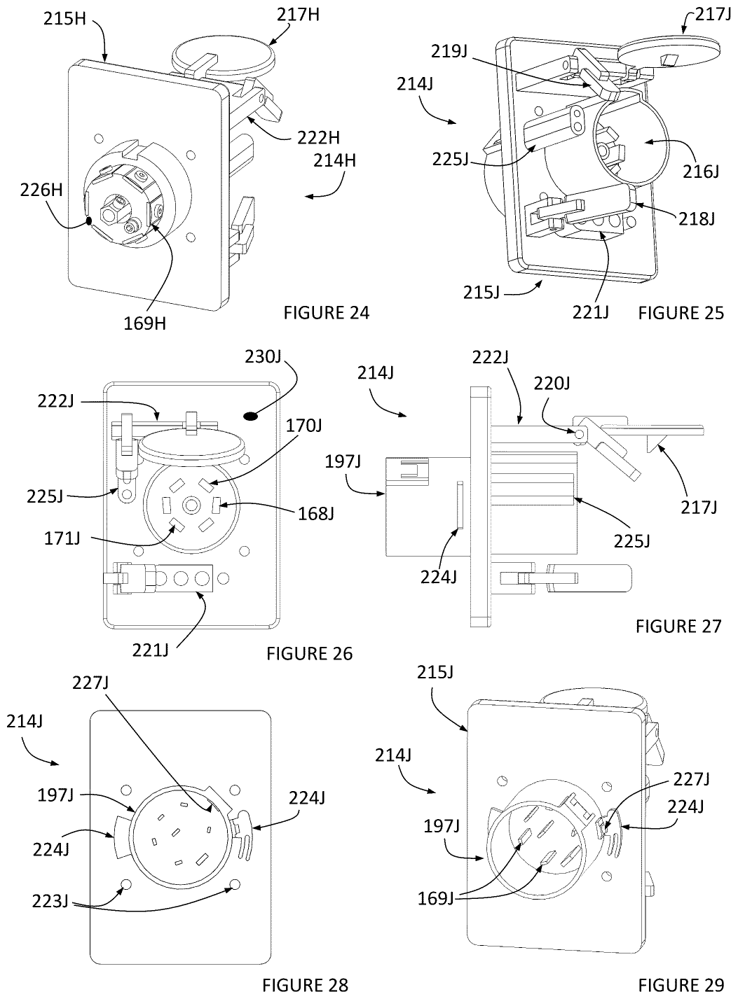

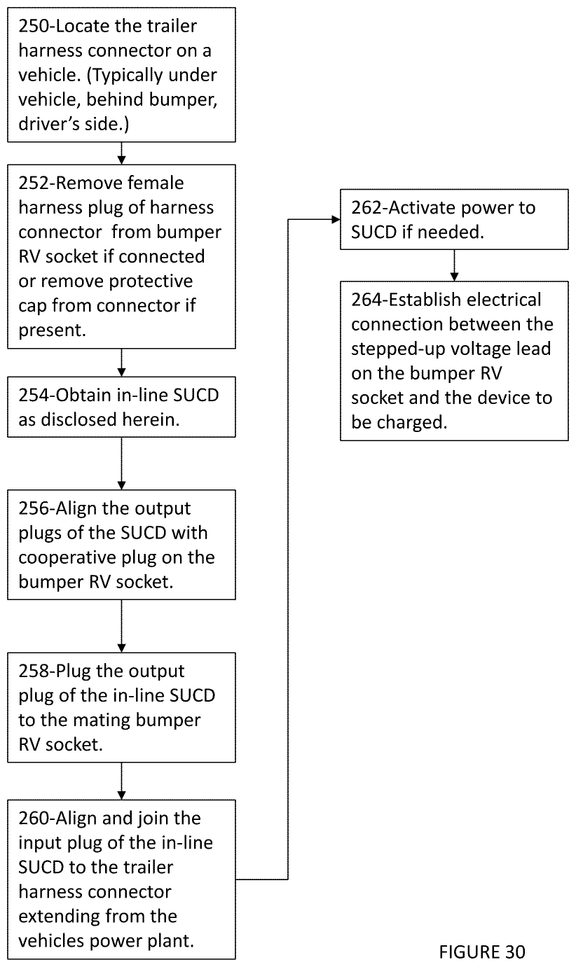

FIGS. 24-29 depict various forms of modified bumper RV sockets 214H, 214J. The FIG. 24 embodiment depicts a bumper RV socket having interior terminals 169H equipped with screws to directly receive the wiring inputs depicted in FIG. 34 from the vehicle. Accessible from the back of the vehicle, the bumper RV socket 214H,214J has a rear-facing standard 7-pin RV socket extending from a socket mount base 215H used to secure the bumper RV socket 214H to the back of the vehicle. The bumper RV sockets in FIG. 25-29 are depicted as USCAR 7-way sockets (although other style sockets can be used). In some cases, the bumper RV sockets are secured to the vehicle using fasteners that extend through mount holes 223J. In other embodiments, twist fins 224J are present since many vehicles include a twist style mounting port on the vehicle to secure the bumper RV socket.

When using an in-line SUCD, there are a variety of configurations for how it can be used. In a first configuration, stepped up positive output voltage from a transformer assembly 150 can be connected directly to the positive auxiliary power terminal 170 of the bumper RV socket 214. In this case, a device such as an electric bike, can be charged from a cable utilizing a 7-pin trailer plug 228 end as depicted in FIG. 33 as a convenient method of charging bikes having batteries above 12 volts. It is noted however, that with the voltage change in the socket, the socket is no longer appropriate for running 12V accessories since the bumper RV socket would be delivering more voltage than the standard 12V associated with most trailers. Additional marking on the bumper RV socket can be used to alert users the socket is not to be used with lower voltage devices. Alternatively, a high voltage/low voltage switch 230G (FIG. 22), 230J (FIG. 26) can be integrated in the bumper RV socket, or integrated in the in-line SUCD to switch the auxiliary power terminal on the bumper RV socket between the standard 12V that bypasses the transformer assembly used for pulling a trailer, to a stepped-up voltage output from the transformer assembly conducive to charging an electric device such as an electric bike.

As yet another alternative, an interior step-up lead 227J (FIG. 28) can be included on the bumper RV socket 214J leading to a stepped voltage lead 225J (FIG. 26). This stepped-up voltage lead can be a dedicated, easily accessible, high voltage plug that can deliver the stepped-up voltage directly to the device needing to be charged through an appropriate fitting charge cable. As an alternative to the interior step-up lead 227J (which would require some modification of the USCAR plug to integrate the stepped-up terminal), the stepped-up voltage can use an interior step-up lead 227J in the form of a screw type, clamp type, or other such terminal (FIG. 29) known in the art. Here, the output circuitry 139 from the transformer assembly 150J is clamped to the screw type terminal and passed to stepped up voltage lead 225J for use in charging. In this case, the standard 7-pin RV socket 216J remains unchanged and provides the standard outputs as seen in FIG. 34 for normal use by a trailer.

In another alternative embodiment, an outlet port 130G with optional clamp and/or seal 131G can be provided on the shell wall 114G or wiring corridor 205F to provide an outlet for the stepped-up voltage. In this case, a charge cable can be coupled with the stepped-up output to again charge an electric bike or other device requiring more than 12V. It is noted that other electrical signals that are not stepped up can simply pass through via conductor between corresponding terminals in the male and female sockets.

The bumper RV sockets of FIGS. 24-29 can include one or more of the following features some of which are known in the prior art. For example, the standard 7-pin RV socket 216J can include a pivoting 7-pin cover with lock tab 217J. The lock tab cooperates with lock catch 113 to prevent a 7-pin trailer plug from falling out of the socket. The lock catch serves the same function when used with a terminal SUCD 102A. Covers such as these, pivot about a cover pivot 220J (i.e. pivot pin) that is positioned at the rear of a lid boss 222J which extends reward from socket mount base 215J. In some embodiments, the bumper RV socket also includes a standard 4-pin RV socket 221J that is known in the art and that is used primarily for trailer lighting. The 4-pin RV socket can also have a removeable 4-pin cover 218J, and the stepped voltage lead 225J can have a stepped voltage cover 219J. The interior terminals 169H in FIG. 24 can also be covered from elements and shorting using a lead cover 226J.

In one embodiment, a method for utilizing an in-line SUCD to supply stepped-up voltage to use for charging a device comprises the following steps. Locate the trailer harness connector on a vehicle extending from the vehicle's powerplant (250), (Typically under vehicle, behind bumper, driver's side.) Remove the female harness plug from the bumper RV socket if present or remove the protective cap from the connector if present (252). Obtain an in-line SUCD as disclosed herein (254). Align the output plug of the in-line SUCD with the cooperative plug on the bumper RV socket (256). Plug the output plug of the in-line SUCD with the cooperative plug on the bumper RV socket (258). Align and join the input plug of the in-line SUCD with the trailer harness connector extending from the vehicles power plant (260). Activate power to step-up RV module (262). Establish electrical connection between the stepped-up voltage lead on the bumper RV socket and the device to be charged (264).

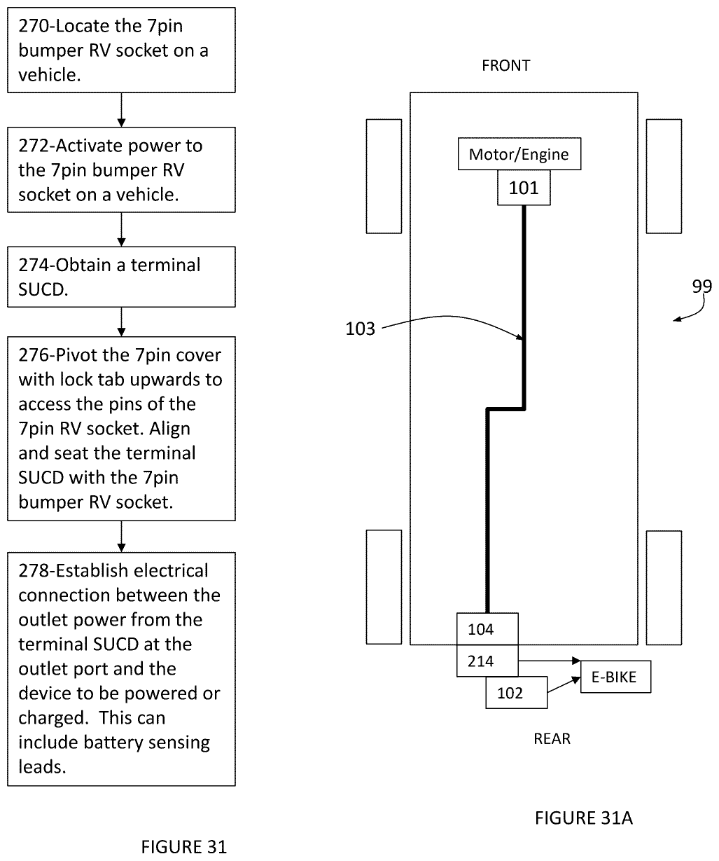

In one embodiment (FIG. 31), a method for using a terminal SUCD to supply stepped-up voltage to use for charging or powering a device comprises the following steps. Locate the 7pin bumper RV socket on a vehicle (270). Activate power to the 7pin bumper RV socket on a vehicle (272). Obtain a terminal SUCD as disclosed herein (274). Pivot the 7pin cover with lock tab upwards to access the pins of the 7pin RV socket. Align and seat the terminal SUCD with the 7pin RV socket (276). Establish electrical connection between the outlet power from the SUCD at the outlet port and the device to be powered or charged. This can include battery sensing leads (278).

FIG. 31A depicts a simple graphic of the underbody of a vehicle 99 with a vehicle powerplant 101 providing power to either an inline SUCD 104 or a terminal SUCD 102 after connection to bumper RV socket 214.

It should be noted that if a vehicle was not originally equipped with a tow package, towing connectors may have to be activated before use (i.e. the powered terminals depicted in FIG. 34). For example, although a vehicle may be equipped with a 7-pin bumper RV socket, power to the positive auxiliary power terminal may not have been activated or included. In some newer vehicles, the positive auxiliary power terminal is activated by computing systems in a vehicle only when the vehicle senses that a trailer is connected to the vehicle. In these cases, the SUCD circuitry can include a small load circuitry as a means to convince the vehicle that a trailer is connected to the vehicle and thus that power should be supplied to the auxiliary power terminal.

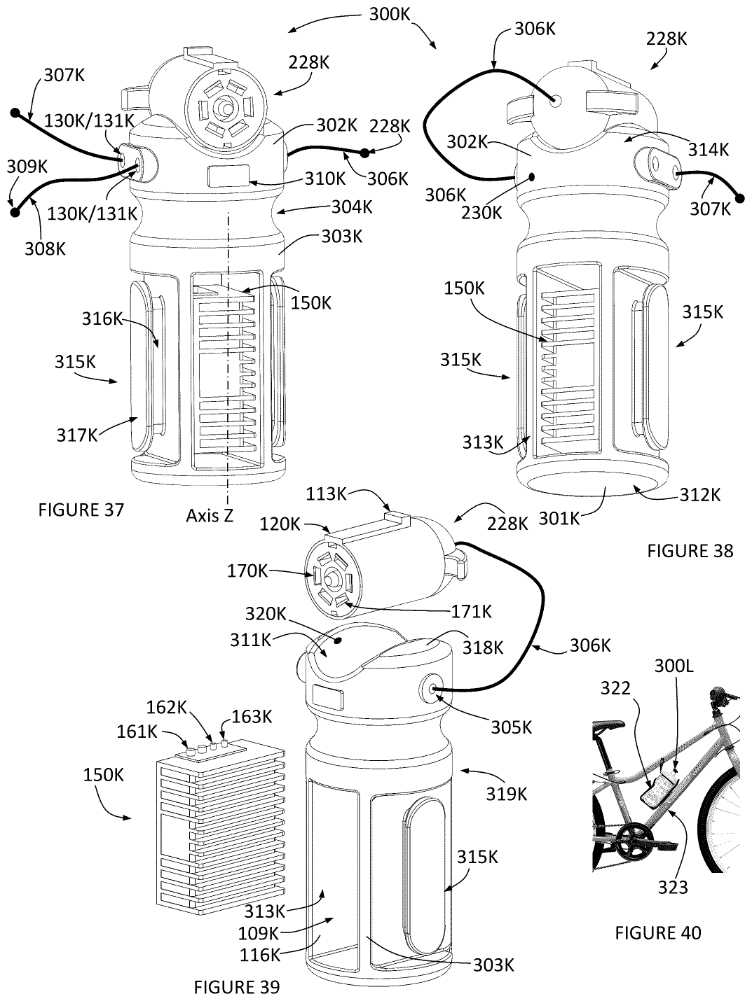

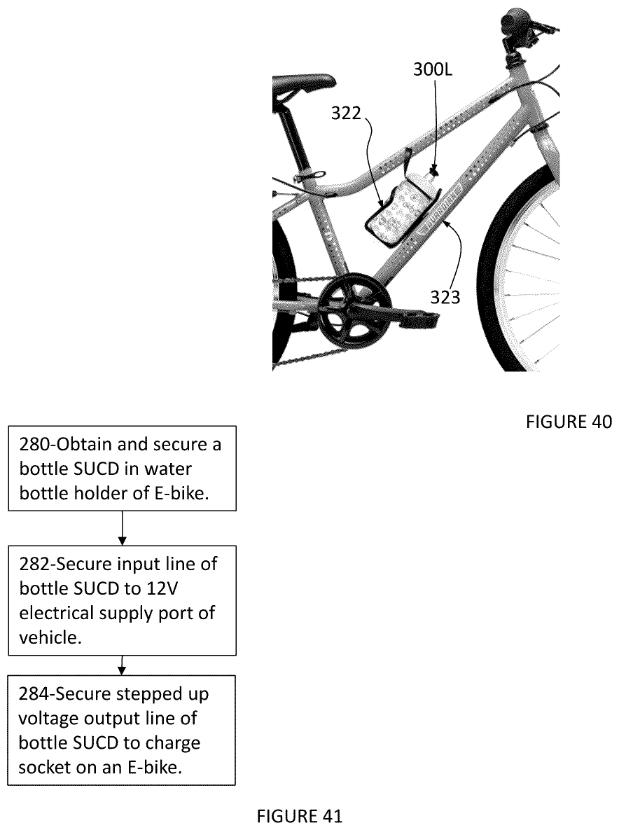

FIGS. 37-39 depicts a bottle SUCD 300K wherein the bottle SUCD comprises a bottle housing 319K having the general form of a standard bicycle water bottle for secure seating within a bicycle's water bottle holder 322. In most cases, this general form is cylindrical, however, clearly the form could comprise other profiles such as a continuous plurality of flats that would complement it being held by a water bottle holder. In preferred embodiments, the bottle SUCD 300K has a housing lower outer face 303K having an outer diameter of 2.875 inch with as much as +/−0.5 inches. In addition, an inset engagement groove 304K can encircle the bottle SUCD housing between housing upper outer face 302K and housing lower outer face 303K. The engagement groove is placed approximately 5 inches +/−0.5 inches upwards from a downward facing housing bottom face 301K located at the bottom of the bottle SUCD.

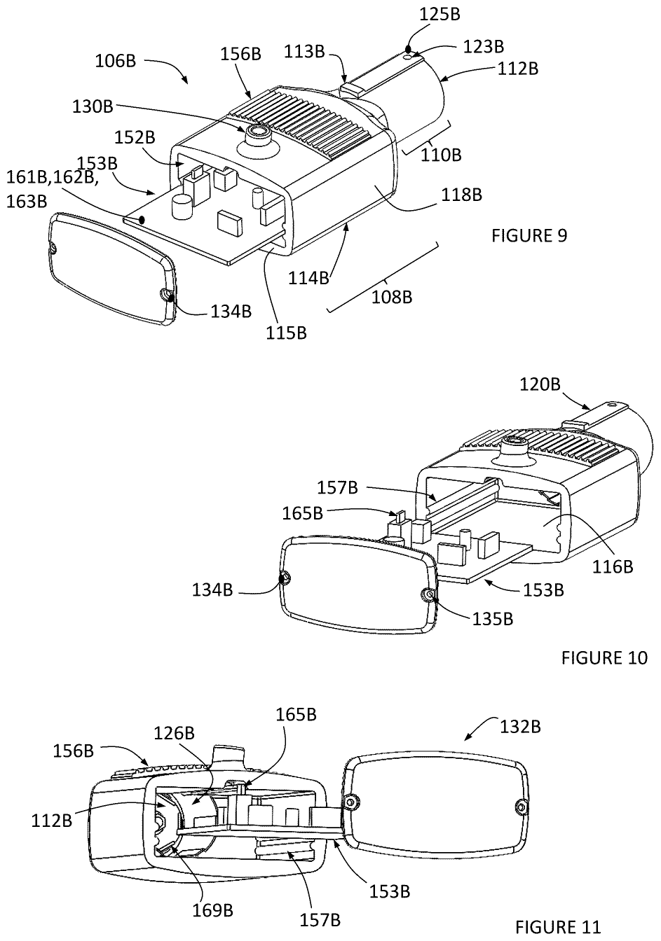

The bottle housing 319K depicted in FIGS. 37-39 comprises a step-up cavity 109K defined by internal faces 116K. Here, the step-up cavity has a generally rectangular profile sufficient for seating and securing a transformer assembly 150K therein using its mount face. In alternative embodiments, those skilled in the art will recognize that the bottle SUCD can be constructed in other configurations, similar to those depicted in FIGS. 9-11 for example. In this alternative, a step-up transformer circuit board is sealed within bottle housing 319K with adjunct cooling fins located outside the bottle housing to draw heat from the circuit board during charging. Again, the transformer assembly 150K and step-up cavity 109K can assume a variety of complementary shapes different than depicted in the Figures, yet operate without loss of function.

In the FIG. 37-39 embodiment, bottle SUCD 300K comprises a bottom wall 312K similar to the bottom of a water bottle that is generally flat for setting on a horizontal surface. Extending upwards from bottom wall 312K are a pair of opposed central walls 313K with internal faces 116K thereon defining step-up cavity 109K. Upwards from the central walls is head wall 314K forming the superior end of the bottle SUCD.

In some embodiments, laterally extending from one or more of central walls 313K is a winding pod 315K for winding cables extending from the SUCD when the device is not in use. This optional feature offers tidy cable storage. The winding pod in this embodiment includes a pod stem 316K rising laterally from a central wall and is topped with a broad pod roof 317K. In alternative embodiments, a circumferential portion of the upper and or lower outer faces are recessed for winding the cables circumferentially about axis Z.

In this embodiment, positioned on head wall 314K is an upward facing housing top face 318K. As an option, a 7-pin seat 311K can be inset in or through housing top face 318K and configured to seat a portion of a 7-pin trailer plug (or 4-pin) for storage. A storage magnet assembly 320 (with metal or opposing magnet) can be used to hold the plug in position until released. Optionally integrated into bottle housing 319K is a charger display 310K operable to provide information to the user through lights or other output the status of the charge process or charge levels of one or more E-bike batteries.

In this embodiment, bottle housing 319K comprises a 12V input port 305K for receiving 12V input via a 12V input line 306K from 7-pin trailer plug 228K (or 4-pin). The input line can be fixed or detachable (i.e. plug). Internal wiring mimics that of FIG. 2. In addition, bottle housing 319K comprises one or more outlet ports 130K which can include a clamp and/or seal 131K or alternatively be in the form of a releasable plug. Extending from the outlet ports are one or more stepped-up output lines with a stepped-up charge plug 309K for plugging into an E-bike for charging (i.e. first stepped-up output line 307K, second stepped-up output line 308K).

It is noted that the bottle SUCD 300L can assume a wide variety of water bottle style profiles allowing it to swap positions with a bicycle water bottle that is secured in a water bottle holder 322 that is fixed/releasably fixed to the seat tube or downtube of a bike frame 323 during bicycle transport.

In a method of charging an electric bike battery in an electric bike, a bottle SUCD is removably secured in a bicycle water bottle holder of the electric bike (280). A 12V input line 306K of the bottle SUCD 300K is electrically coupled via a 12V input port 305K to a 12V supply from a vehicle (i.e. 7-pin or 4-pin bumper RV socket) (282). One or more stepped-up output lines (i.e. 307K,308K) from the bottle SUCD are then coupled to an electric bike while the E-bike is stationary or in transport by a motor vehicle (284).

It is noted that the terms “substantially” and “about” and “generally” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

The foregoing invention has been described in accordance with the relevant legal standards, thus the description is exemplary rather than limiting in nature. Variations and modifications to the disclosed embodiment may become apparent to those skilled in the art and fall within the scope of the invention.

1. A step-up charging device for coupling with the exterior electrical supply on a vehicle comprising:
a shell body;
a step-up transformer;
a portion of said shell body housing an RV electrical plug operable for releasable coupling with said exterior electrical supply on a vehicle;
said RV electrical plug comprising a power terminal operable to receive power from said vehicle;
said RV electrical plug comprising a ground terminal;
said step-up transformer secured to a portion of said shell body; and,
output circuitry extending from said step-up transformer operable to couple with and charge an electrical device.

2. The step-up charging device of claim 1 wherein said step-up transformer is positioned within 5 inches of said RV electrical plug in said shell body.

3. The step-up charging device of claim 1 wherein said step-up charging device is plugged into a standard 7-pin RV socket of a vehicle in an operative mode.

4. The step-up charging device of claim 1 wherein said output circuitry delivers between 30 volts and 90 volts DC.

5. The step-up charging device of claim 1 further comprising:
a heat sink body; and,
wherein said step-up transformer is disposed in said heat sink body.

6. The step-up charging device of claim 1:
said step up transformer comprising a circuit board;
said shell body comprising a circuit board cavity; and,
wherein said circuit board is enclosed within said circuit board cavity.

7. The step-up charging device of claim 1 wherein an exterior portion of said shell body is in the form of a 7-pin RV plug.

8. The step-up charging device of claim 1 wherein said shell body comprises one or more shell vents for cooling of said step-up transformer located inside said shell body.

9. A step-up charging device for coupling between an electrical powerplant of a vehicle and a RV socket positioned at the rear of the vehicle comprising:
a shell body;
a step-up transformer;
a first electrical plug disposed in a portion of said shell body operable for releasable coupling with circuitry supplying power from said vehicle powerplant;
a second electrical plug disposed in a portion of said shell body operable for releasable coupling with circuitry extending from said RV socket;
said step-up transformer secured to a portion of said shell body; and,
wherein said step-up transformer is operable to step-up voltage from said electrical powerplant and supply said stepped-up voltage to said RV socket for delivering a charge to an electrical device.

10. The step-up charging device of claim 9 wherein said first electrical plug and said second electrical plug are compatible with standards for an USCAR 7-way socket or a Dodge socket.

11. The step-up charging device of claim 9 wherein said step-up transformer is secured to said shell body between said first electrical plug and an opposing said second electrical plug.

12. The step-up charging device of claim 9 further comprising one or more shell vents in said shell body for cooling of said step-up transformer disposed inside said shell body.

13. The step-up transformer device of claim 9 further comprising:
a step-up cavity formed within said shell body; and,
said step-up transformer secured in said step-up cavity.

14. The step-up charging device of claim 9 further comprising:
said RV socket being a standard 7-pin RV socket;
a socket mount base;
said standard 7-pin RV socket disposed on said socket mount base;
a stepped voltage lead disposed on said socket mount base for suppling said stepped-up voltage from said step-up transformer to a chargeable device; and,
wherein said stepped-up voltage lead is spaced from said standard 7-pin RV socket on said socket mount base.

15. The step-up charging device of claim 9 further comprising:
said RV socket being a standard 7-pin RV socket;
a stepped-up voltage lead for suppling said stepped-up voltage from said step-up transformer to a chargeable device; and,
wherein said stepped-up voltage lead is integral to said standard 7-pin RV socket.

16. The step-up charging device of claim 9 wherein said second electrical plug is electrically coupled directly to said RV socket.

17. A step-up charging device for coupling with the exterior electrical supply on a vehicle comprising:
a bottle housing having a general form of a bicycle water bottle;
a step-up transformer for stepping up voltage from said vehicle;
said step-up transformer disposed in said bottle housing;
an RV electrical plug electrically coupled to said step-up transformer operable for releasable coupling with said exterior electrical supply on said vehicle;
said RV electrical plug comprising a power terminal operable to receive power from said vehicle;
said RV electrical plug comprising a ground terminal; and,
output circuitry extending from said step-up transformer operable to couple with and charge an electrical device.

18. The step-up charging device of claim 17 wherein said bottle housing has an outer diameter in the range of 2.875 inches plus or minus 0.5 inches.

19. The step-up charging device of claim 17 wherein said bottle housing further comprises:
a bottom face at the bottom of said bottle housing;
an engagement groove encircling said bottle housing for receiving a portion of a bicycle bottle holder; and,
wherein said engagement groove is positioned between 4.5 inches and 5.5 inches upwards from said bottom face.

20. The step-up charging device of claim 17 further comprising:
at least one input line for receiving power from said vehicle;
at least one output line for delivering stepped-up power;
a winding pod; and,
wherein said winding pod is operable for winding an input line or output line around said winding pod.
